(19) United States
(12) Patent Application Publication
(10) Pub. No.: US 2017/0215684 A1
(43) Pub. Date: Aug. 3, 2017

(54) JOINT FILLER SHAVER

(71) Applicant: Progressive Fastening Systems, Inc., Ontario, CA (US)

(72) Inventor: Scott BURTON, Yucaipa, CA (US)

(21) Appl. No.: 15/421,200

(22) Filed: Jan. 31, 2017

Related U.S. Application Data
(60) Provisional application No. 62/289,853, filed on Feb. 1, 2016.

(51) Int. Cl. A47L 13/08; B26B 5/00

(52) U.S. Cl. CPC A47L 13/08; B26B 5/005

(57) ABSTRACT

A motorized joint filler scraper or shaver that rapidly and smoothly shaves joint filler flush to a floor. Aspects may include a blade attachment component that allows the blade to rotate relative to the frame of the shaver, allowing the blade to maintain contact with uneven surfaces and to be rotated to avoid dulling the blade through use of a single side. Further aspects may include an operator platform that allows the operator to ride along with the scraper.

### CROSS REFERENCE TO RELATED APPLICATION

The present application claims priority to U.S. Provisional Patent Application Ser. No. 62/289,853, entitled “JOINT FILLER SHAVER”, filed on Feb. 1, 2016, the entire contents of which are incorporated herein by reference into the present application.

BACKGROUND

When preparing flooring, such as concrete floors for industrial or retail buildings, the floor may be formed with joints between sections of the floor. These joints may be filled with a joint filler, e.g., to protect brittle edges of concrete floors. A liquid filler may be applied by overfilling the joints. Then, the filler can be scraped off with a scraper, such as a razor blade shaver. A typical scraper includes a razor blade attached to a pole in order to manually scrape excess filler from the upper surface of the concrete floor.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Manually scraping/shaving joint filler from a floor can be an exhausting job requiring many hours of manual labor. In addition to the amount of labor involved in the removal, as the person removing the filler becomes tired, their workmanship may deteriorate causing irregularities in the floor. For example, the person scraping the filler may tend to jab at the filler causing a rough surface or may glide over the top, leaving behind a layer of filler that should be removed. This can cause an unsightly or uneven finish on the surface.

Presented herein is a motorized joint filler scraper, also referred to interchangeably herein as a “shaver,” that rapidly and smoothly shaves joint filler flush to a floor. Aspects may include a blade attachment component that allows the blade to rotate relative to the frame of the shaver, enabling the blade to maintain contact with uneven surfaces and to be rotated to avoid dulling the cutting edge of the blade through use of a single side. Further aspects may include an operator platform that allows the operator to ride along with the shaver. The aspects presented herein enable a single operator to scrape/shaver filler in a dramatically efficient manner and provide an improved, consistent finish.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example floor joint being filled with a filler.

FIGS. 2A and 2B illustrate a manual filler scraper.

FIG. 3 illustrates an example shaver in accordance with aspects presented herein.

FIG. 4 illustrates an example intersection of floor joints filled with filler.

FIG. 5 illustrates an example shaver and method of shaving a floor joint intersection in accordance with aspects presented herein.

FIG. 6 illustrates a side view of a shaver with and without a cover in accordance with aspects presented herein.

FIG. 7 illustrates a view of a shaver with the cover removed, in accordance with aspects presented herein.

FIG. 8 illustrates a view of a shaver from the side of the user platform, in accordance with aspects presented herein.

FIGS. 9A and 9B illustrate rotation of the blade with respect to the frame, in accordance with aspects presented herein.

FIG. 10 illustrates an example kickstand in accordance with aspects presented herein.

FIGS. 11A and 11B illustrate an example transport mechanism for the shaver in accordance with aspects presented herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

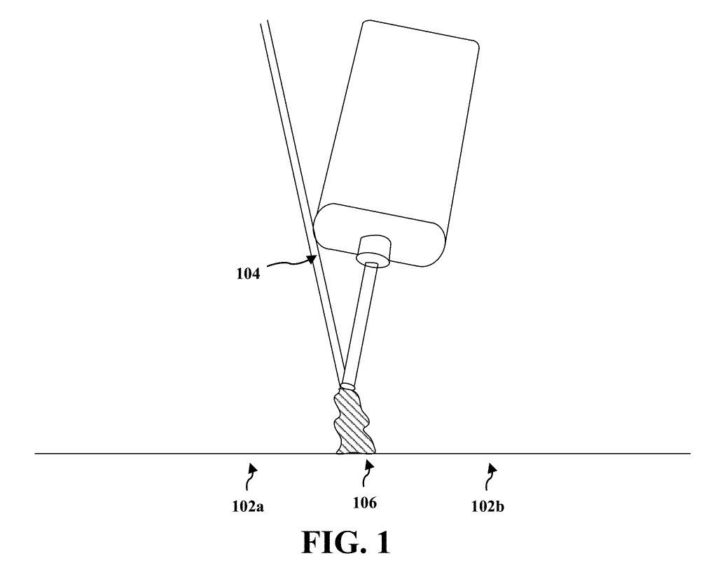

FIG. 1 illustrates an example floor having a joint, or opening, between sections of the floor. FIG. 1 shows a concrete floor having a joint 104 between a first section 102a of concrete and a second section 102b of concrete. A filler 106 is placed in the joint 104 between adjacent sections of concrete 102a, 102b. The filler may comprise, e.g., among others, an elastomer joint filler such as polyurea, semi-rigid epoxy, urethanes, etc. The filler may be applied by overfilling the joint. After the filler has cured, the excess filler can be scraped, e.g., level to the floor.

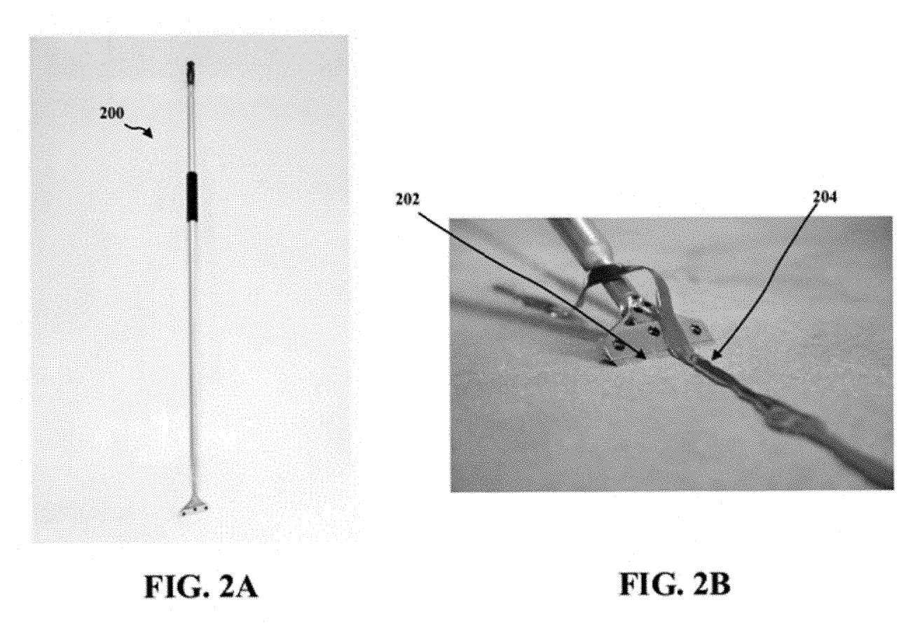

FIG. 2A illustrates a scraper 100 having a pole with a razor blade that can be used to manually scrape the excess filler by shaving the filler 106 level with the concrete sections 102a, 102b of the floor. FIG. 2B illustrates a razor blade 202 placed at the surface of the floor scraping/shaving the excess filler 204.

Manually scraping joint filler from a floor can be an exhausting job requiring many hours of manual labor. In addition to the amount of labor involved in the removal, as the person removing the filler becomes tired, their workmanship may deteriorate causing irregularities in the floor. For example, the person scraping the filler may tend to jab at the filler causing a rough surface or may glide over the top, leaving behind a layer of filler that should be removed. This can cause an unsightly finish on the surface.

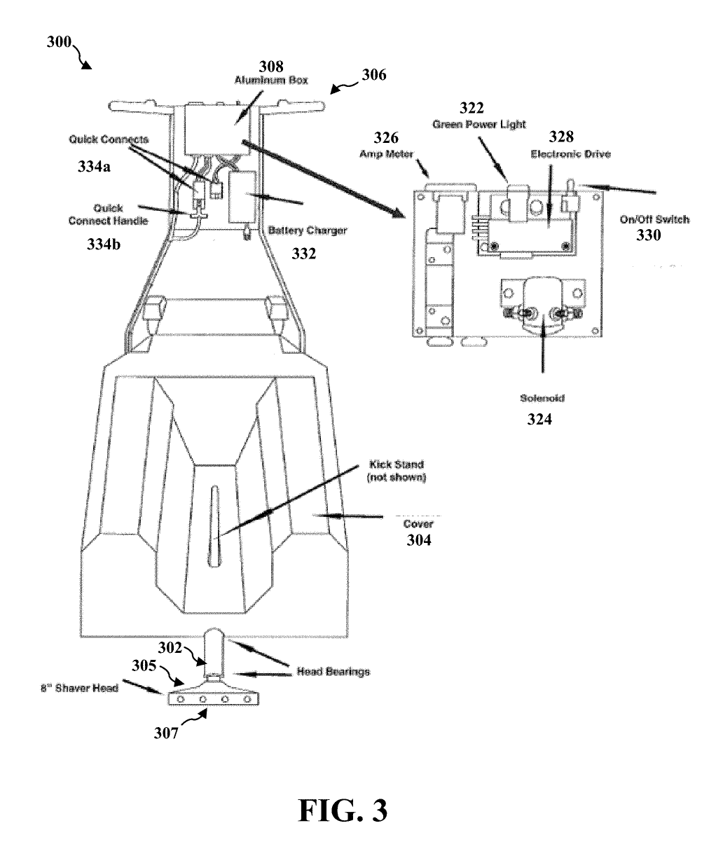

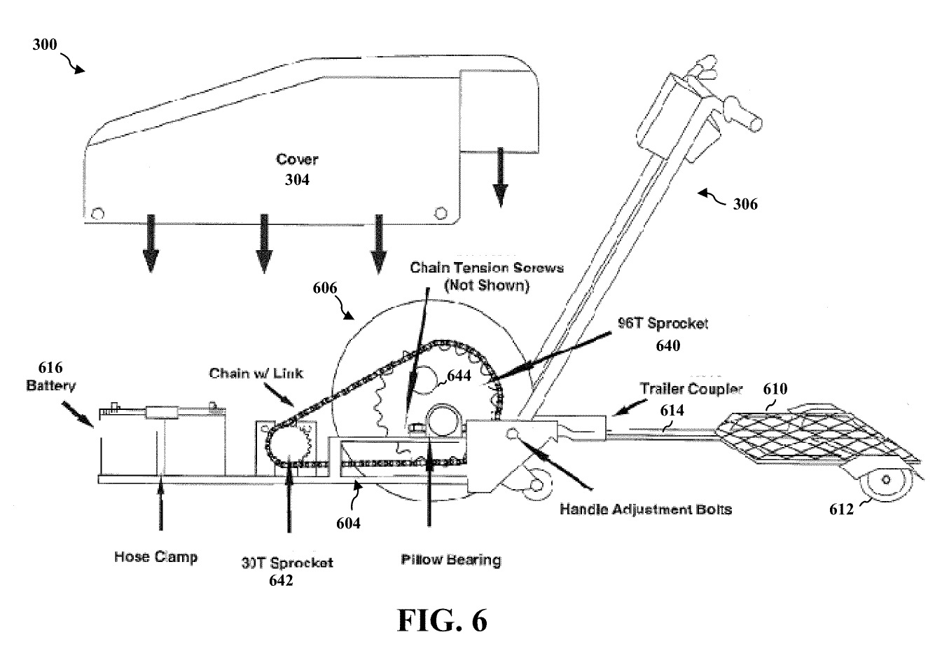

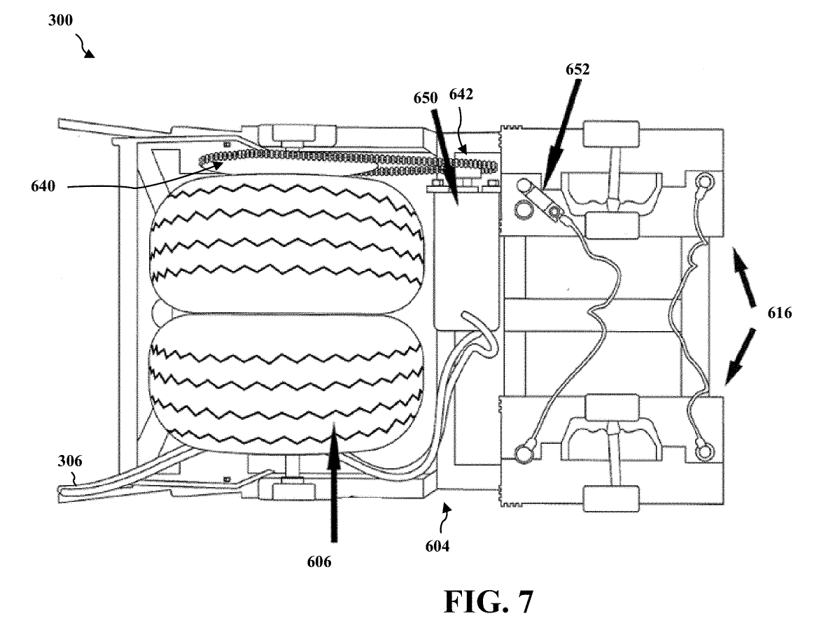

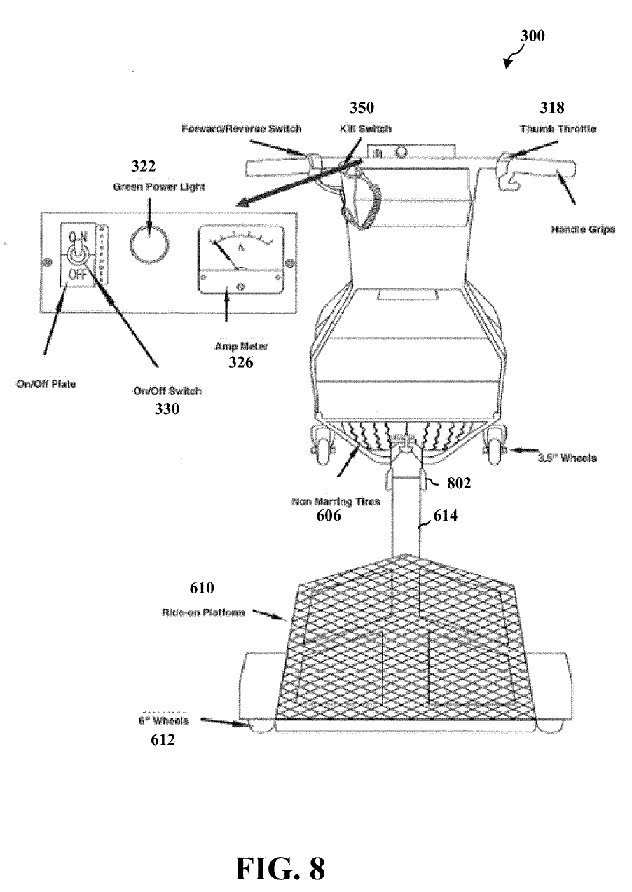

FIG. 3 illustrates example aspects of a motorized, power operated joint filler shaver 300 that rapidly and smoothly shaves joint filler flush to a floor. The shaver 300 may also be referred to as a “scraper” herein. The shaver 300 includes a frame 60, shown in more detail in FIGS. 6, 7, 8 and 8. FIG. 6 illustrates a side view of the shaver 300 having the cover removed. FIG. 7 illustrates a top view of a portion of the shaver 300 having the cover removed. FIG. 8 illustrates a view of the shaver from the side of the user platform 610 opposite the blade 307.

The shaver 300 may include a protective cover 304 that functions as a housing for the moving parts, such as the motor, gears, chain, wheels of the shaver 300. The cover at least partially encloses the motor and other moving parts, protecting these parts from debris and protecting the operator and nearby people from coming into contact with the moving parts. The cover may be removable. The cover 304 may have an connector that releasably attaches the cover to the frame.

An adjustable handle 306, such as the handlebars illustrated in FIG. 3, may extend from the frame. The handle 306 may be used to maneuver and guide the shaver.

Shaver 300 may include at least one blade attaching component 302 that extends from the frame 300 toward the floor. As shown in FIG. 3, the blade attachment component 302 may extend from the frame and through an opening in the cover 304. Although FIG. 3 is illustrated with only a single blade attaching component 302, for certain applications, a shaver may be configured with more than one blade attaching component 302.

The blade attaching component 302 is coupled to or fixed to the frame so that the blade is able to move relative to the frame. The blade attaching component 302 is configured to receive a blade 305 angled so that a cutting edge 307 of the razor blade 305 rests at the floor surface. As the shaver 300 moves, the cutting edge 307 of the razor blade 305 slides along the surface of the floor, shaving filler that extends above the floor surface and leaving joints having filler being smoothly level with the floor surface. The shaver comprises a single axle, with wheels 303, as illustrated in FIGS. 6, 7, and 8 that allow the shaver 300 to roll across the surface of the floor. Although two wheels are illustrated, additional wheels may be used. The wheels are driven by the motor. As described infra, chains, gears, etc. may be powered by the motor to cause the wheels to rotate and drive the shaver across the surface of the floor, causing the blade to shave the filler level with the surface of the floor.

The frame may be configured and rotatably connected to the wheels 606 so that, at rest or without the operator pushing down on the handles 306, the blade 305 is pressed against the floor with at least a portion of the weight of the shaver frame and cover. The cover may be a heavy duty protective cover that provides added weight to press the blade against the floor. The blade illustrated in FIG. 3 is an 8″ blade, although other blade sizes may be used.

The frame may be rotatably coupled to the wheels so that an operator can raise the cutting edge of the razor blade up and away from the surface of the floor by pushing the handle 306 toward the floor. The ability to quickly and easily lift the blade off of the floor can be very important. As the handle 306 and the blade attaching component 302 are both coupled to the frame in a fixed manner, these components both move with the frame. Therefore, when the operator pushes the handle 306 down, the movement causes the frame to pivot on the wheels and lifts the blade away from the floor.

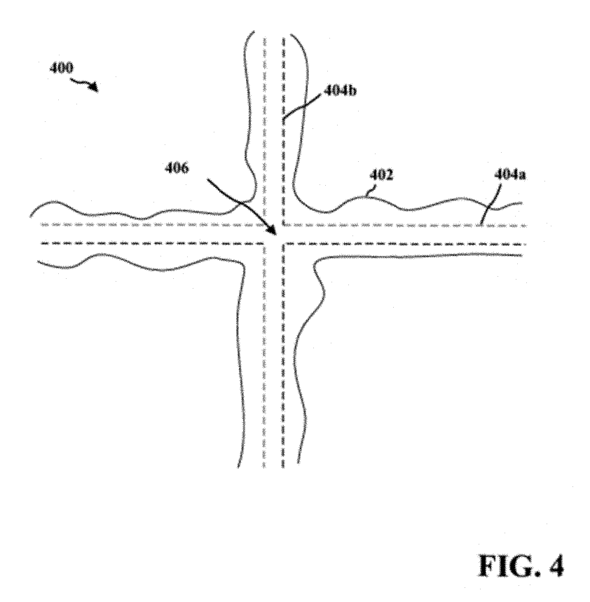

For example, when the blade reaches an intersection of joints, such as the intersection 400 illustrated in FIG. 4, the operator can simply lift the blade away from the floor by pushing on the handles in order to avoid running the blade directly into the filler at the intersecting joints. Once the shaver has driven past the intersection, the operator can return the blade 305 to the floor by allowing the handles to raise to their original position. FIG. 4 illustrates an example of an intersection 400 of two joints 404a and 404b with filler 406 overfilling the joints 404a and 404b. The two joints intersect or cross at 406. As an operator shaves the filler extending above one of the joints, he may come to multiple intersections with other joints. As he approaches each of the intersections, the operator can simply raise the blade in order to avoid breaking the blade.

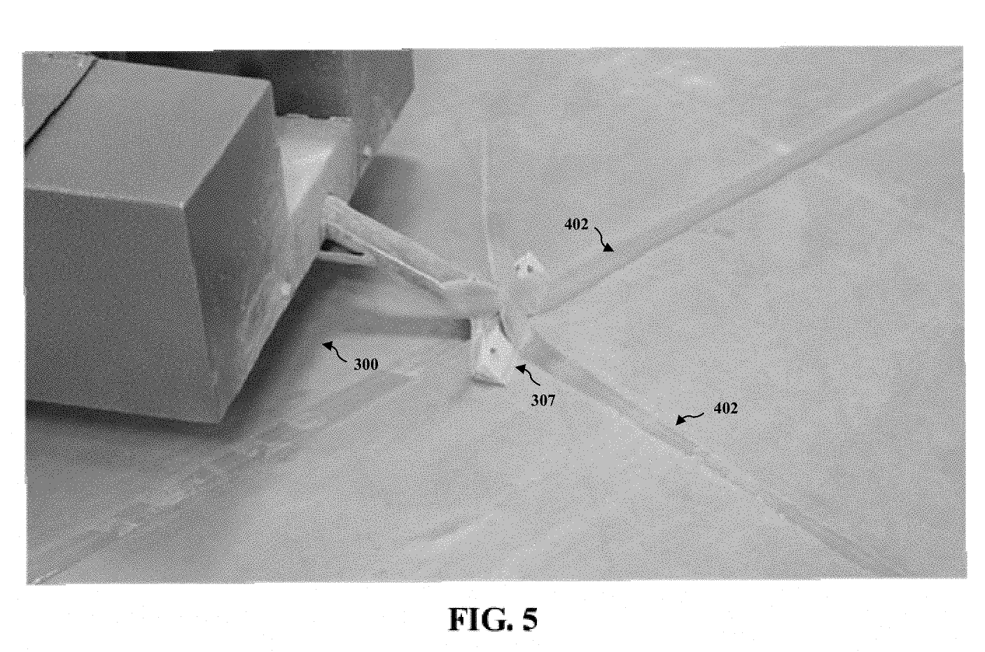

The intersections may be shaved manually. In one example, the shaver may be used to shave the excess filler at joint intersections by driving the shave across or through the intersection at an angle to both joints, as illustrated in FIG. 5.

Handle 306 may be provided with padding. The width of the handles and the padding provide operator comfort while driving the shaver and pushing the handles to lift the blade.

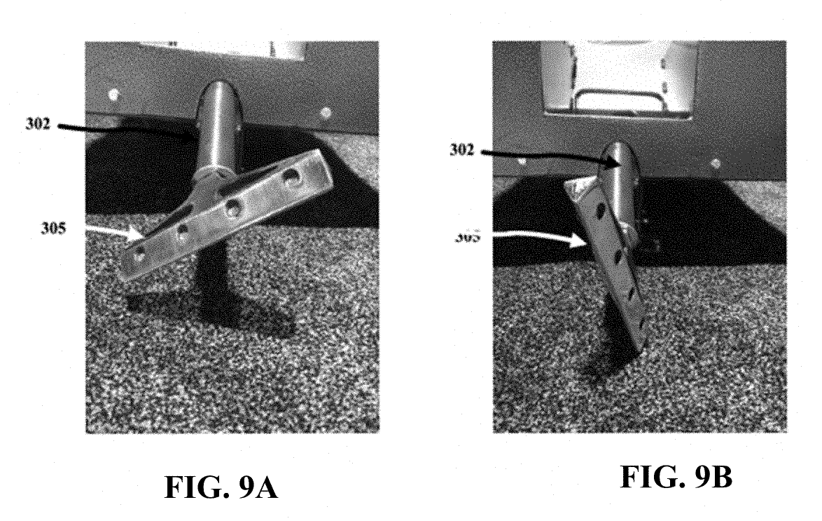

The blade may be rotatably coupled to the blade attaching component 302, also referred to herein as the “head” of the shaver. For example, the blade 305 may be able to rotate fully, or 360° , with respect to the blade attaching component 302. FIGS. 9A and 9B illustrate the rotation of the blade 305 in opposite directions with respect to the blade attaching component 302, and therefore the frame 604. Among other means for allowing the blade to rotate relative to the attaching component 302, and therefore relative to the frame, bearings may be used. The blade attaching component 302 is fixed, or coupled in a fixed manner, to the frame. Positioning bearings between the blade 305 and the blade attaching component 302 enables the blade 305 to rotate relative to the attaching component 302 and therefore with respect to the frame. This provides a number of benefits. For example, bearings within the shaft allow the blade to swivel and move to maintain contact with the floor, even when the floor surface is uneven or includes irregularities. This also allows the blade to be periodically rotated to use the opposite cutting surface of the blade to shave the filler, e.g., by rotating the blade 180 degrees. The blade can be rotated simply by lifting the blade from the floor, by pushing on the handles or otherwise causing the shaver to pivot on its wheel to lift the blade off of the floor. The blade can then be manually rotated or turned to the desired position. Then, the shaver can be returned to the position with the blade placed against the floor. This allows the blade to self-sharpen by using both sides of the cutting edge 307 of the blade 305. It allows a more efficient use of the blade, avoiding dulling the cutting edge 307 of the blade 305 through use of only a single side of the cutting edge 307.

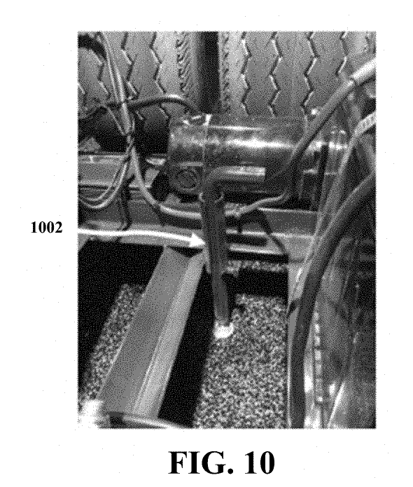

As illustrated in FIG. 10, a stand 1002 may be provided that maintains the shaver in a position with the blade 305 lifted from the floor. This can be used to allow the user to rotate the blade and/or to change the blade. The stand may be a separate component that is used to prop the blade end of the shaver. In another example, the stand may be coupled to the shaver and may move to a position between the frame and the floor and may retract to allow the shaver to return to a position with the blade against the floor. The stand may move into position by rotating or extending to the position holding the shaver with the blade raised from the floor.

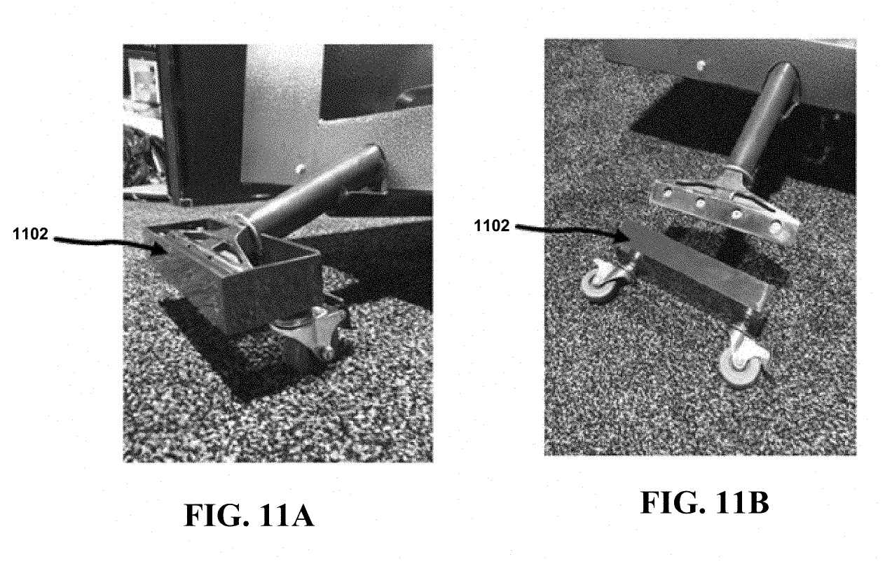

Additionally, a transport mechanism, such as transport wheels may be used to allow the shaver to be moved with the blade in a position raised from the floor. FIGS. 11A and 11B illustrates one example of such transport wheels 1102. Similar to the stand, the transport wheels may either be configured as a separate component from the overall body of the shaver or may be coupled to the shaver 300. The front portion, or the portion of the shaver from which the blade extends, may rest on or attach to the transport wheels. Alternately, the transport wheels may be coupled to the shaver and may be moved extend or rotate into position to provide contact with the floor. The transport wheels may then retract or rotate away from contact with the floor in order to allow the shaver to be operated to shave filler. The transport wheels allow the shaver to be moved, whether by the operator pushing the shaver or driving the shaver, without the blade making contact with the floor.

Common sizes of blades used in manual scrapers include 4″, 5″, and 8″ blades. Blade heads are available in 4″, 5″, and 8″ with corresponding blades in each size of blade head. FIG. 3 illustrates an 8″ blade used with the scraper 300. The blade attaching component 302 may be configured to interchangeably receive blades of different widths. For example, for certain applications, an operator may remove an 8″ blade and connect a smaller blade, such as a 5″ blade to the blade attaching component. A larger blade, such as a blade larger than 5″, or at least 8″ may provide the added benefit of moving the removed filler, as well as other debris, away from the scraper so that the scraper 300 does not run over the removed filler and the removed filler/debris does not bunch up in front of the shaver or become lodged in a wheel or other component. In one example, a blade with a cutting edge that is larger than 8″ may be used.

FIGS. 6 and 8 illustrate an operator platform 610 that allows the operator to ride along with the shaver 300. This allows a single operator to scrape filler in a dramatically efficient manner and providing an improved and consistent finish. In another example, a shaver 300 may be configured without a user platform so that an operator walks along with the shaver 300 as it moves. In another example, the shaver 300 may include a connection for releasably receiving an operator platform so that the shaver 300 can be operated with or without the operator platform 610, depending on user preference, on the scraping job, etc. In addition to having a removable operator platform, the operator platform may be configured in a manner that allows the platform to fold out of the way so that a user can operate the shaver 300 in a walking mode without using operator platform and without removing the operator platform from the shaver 300. The user platform may increase the leverage of the operator to push down on the handles in order to lift the blade off of the floor, thus reducing the strain on the operator when crossing other joints.

The operator platform may comprise at least two wheels that allow the operator platform to move along with the shaver 300. The user platform may include a standing surface on which a user stands to ride along with the shaver 300. A mesh platform is illustrated in FIG. 3, although other types of materials may be used for the platform, such as a solid platform material. The user platform may connect to the frame of the shaver 300, e.g., using a ball and socket connection 802, as illustrated in FIG. 8, although other types of hitches or connections may be used. FIG. 6 illustrates an extension 614 that operatively couples the user platform 610 to the frame of the shaver 300.

The user platform may comprise casters 612 that allow the user platform to move freely with the shaver. The casters may comprise a rounded portion. As pieces of filling are being removed, the rounded caster shape allows the wheels to more easily handle such debris, without jamming. The casters may comprise a fender, such as a steel fender that provides protection from debris that may be thrown up by the wheels. The wheels may be non-marring wheels, where any of the color, material, etc. is selected to avoid leaving a mark on the flooring. For example, non-marring wheels for concrete may be made of a lighter color, such as grey, and may comprise a material that does not tend to leave marks on concrete. The use of non-marring tires can be important as some tires may leave marks on a floor which building owners, stores, etc. do not want.

The wheels coupled to the frame of the shaver may similarly be non-marring wheels. The wheels may also comprise a fender.

This shaver machine can be powered in a number of ways. The shaver 300 may be configured to plug into an outlet for power. In another example, the shaver 300 may be powered using fuel, such as gas or propane. In another example, the shaver 300 may be operated by an electric motor. For example, the shaver may be powered by an electric DC power source such as a battery 616, or by multiple batteries. In one example, the shaver may be powered by two or more batteries, such as illustrated in FIG. 7. The batteries may comprise quick disconnects. A battery charger 332 with quick connects, e.g., 334a,b may be used to quickly and easily recharge the batteries. With a battery, the shaver is cordless and can be operated independent of a connection to an outlet. Additionally, the battery operated shaver does not cause fumes that might be associated with gas or other fuels. This is important, as many of the floors on which the shaver may be used will be indoors. The battery powered shaver does not have fuel fumes and operates quietly so that it is not noisy or bothersome to others in the area.

The shaver 300 can be chain driven, e.g., as illustrated in FIGS. 6 and 7. The motor 650 and gearing may be configured to provide the torque and speed needed to cut filler at a clean and rapid pace. For example, the gears may be selected to provide additional torque rather than speed. In FIGS. 6 and 7, two gears are illustrated, a larger gear 640 having approximately 96 teeth and a smaller gear 642 having approximately 25 teeth. An access opening 644 may be located on the larger gear, e.g., the gear having approximately 96 teeth, as illustrated in FIG. 6. The access opening provides access to a tire valve in order to adjust the air pressure in tire(s) 606. These chain driven gears 640, 642 provide one example of gearing that provides torque needed to drive the blade to smoothly shave filler.

An electronic drive 328 may be coupled to the frame. In FIG. 3, an example electronic drive 328 is coupled to the frame within a housing 308 near the handle 306. The example housing in FIG. 3 for the electric drive is an aluminum box. The electric drive may also be placed in a different position or within a different type of housing. The drive may be a variable speed drive that allows the operator to control the speed of the shaver. A throttle may be provided to allow the user to control the movement of the shaver 300. In FIG. 8, a thumb control 318 is provided near the handle 306. However, control of the shaver may be provided in other ways than the thumb control of FIG. 3. A lever or other type of drive mechanism may be provided near the handle or within arm reach of the operator to control the motion and speed of the shaver. In another example, a pedal or other mechanism can be provided that allows the operator to drive or control the motion/speed of the shaver using their foot or leg. In one example, the throttle or drive control may be configured to cause the shaver to idle in a position without moving unless the operates presses the throttle to cause the shaver to move. This provides added safety so that shaver does not continue to move if the operator falls or is knocked from the platform. In one example, a kill switch 350 or a kill feature may be added for additional safety. The electronic drive may be connected to a solenoid 324 that enables the kill switch to stop the machine 300 as intended. The solenoid 324 may also disengage the motor enabling the machine to be manually pushed. The motor may automatically regenerate electricity and provide the generated electricity to the batteries while the motor is engaged. Batteries 616 may be coupled to a fuse 652. An amp meter 326 may be used to monitor the amps of the motor so as to not overheat and damage the motor by running it too hard. A green “On” light 322 may illuminate when the machine is powered on. This provides a visual cue to operators when the machine is turned on and provides a visual reminder to the operator to turn the machine off when not in use so as to avoid draining the batteries, e.g., via on/off switch 330.

Although the shaver can be configured to be driven only in a forward motion, in another example, the shaver may be configured to be driven in both forward and reverse. Sooner or later joints abut a wall or equipment. By providing the ability to drive the shaver in reverse, e.g., by flipping a switch, the operator may simply raise the blade off of the floor by pushing down on the handles and backing up into position for the next area using the thumb control.

A container, such as a basket for extra blades and parts, may be provided on the shaver. Although the container can be located at other positions on the shaver, in one example, the container may be located on the frame near the handles. For example, the container may be placed at a position that a user can reach the container while standing at the operator platform.

At least one light may be provided on the shaver. A light, or multiple lights, may be provided on the front, or shaving side, of the shaver. The lights may be positioned at the front of the cover. The lights may be coupled to the frame and may shine through the cover, e.g., through an opening or a translucent portion of the cover. The lights may be configured to emit light toward the ground and may emit light that shines out from beneath the cover. Additionally, at least one light may be provided on the rear of the shaver. Such a rear light may be positioned on the frame, cover, or on the operator platform. The light(s) for the front may be different from the light(s) for the rear of the shaver. For example, the lights for the front may be brighter or a different color. The lights for the front may be selected to provide extra light for the operator, as warehouses may be fairly dark while under construction. The rear light may be a different color, such as red, in order to allow a person at a distance to recognize which direction the shaver is moving. Additionally, the rear light may flash, while the front lights may emit a steady light.

In one example, with the ride along operator platform, the weight and dimensions may be approximately 296 lbs., with the machine being approximately 27″ wide, 40″ high, 9′2″ long. In another example, the weight may be approximately 300 lbs., having dimensions of approximately 27″ wide, 43″ high, 7′2″ long.

The shaver does the work of a dozen workers with hand tools and provides a consistent shaved profile. Thus, it is more efficient and provides a smoother, more uniform finish. In addition, workers get tired as the day goes on which causes poor workmanship. Operating this machine is a simple push of the thumb control.

The scraper is capable of shaving at least one mile of joints within an hour. It provides a consistent shaved profile.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “component,” “mechanism,” “element,” “device,” and the like may not be a substitute for the word “means.” As such, no claim element is to be construed as a means plus function unless the element is expressly recited using the phrase “means for.”

What is claimed is:

1. A joint filler shaver comprising:
a frame;
a motor coupled to the frame and configured to drive the shaver in at least one direction;
a handle extending from the frame; and
a blade attachment component coupled to the frame and configured to receive a blade in a rotatable manner, wherein the blade rotates relative to the blade attachment component.

2. The shaver of claim 1, further comprising:
at least two wheels coupled to the frame in a manner that allows the frame to pivot with respect to the wheels,
wherein the frame is coupled to the wheels so that at least a portion of the weight of the shaver causes the blade to press against a floor.

3. The shaver of claim 2, wherein the frame is coupled to the wheels so that the frame pivots with respect to the wheels when leverage is applied to the handle to push the handle toward the floor and causing the blade to lift away from the floor.

4. The shaver of claim 2, further comprising a cover at least partially enclosing the motor and the wheels.

5. The shaver of claim 4, wherein at least a portion of the weight of the cover also causes the blade to press against the floor.

6. The shaver of claim 2, wherein the wheels comprise non-marring wheels.

7. The shaver of claim 2, wherein the shaver comprises a single axle.

8. The shaver of claim 1, further comprising bearings positioned between the blade attachment component and the blade to allow the blade to rotate with respect to the blade attachment component.

9. The shaver of claim 1, further comprising:
an operator platform configured to couple to the frame of the shaver.

10. The shaver of claim 9, wherein the operator platform comprises rounded casters.

11. The shaver of claim 1, further comprising a variable speed drive.

12. The shaver of claim 11, further comprising a throttle controlling the variable speed drive.

13. The shaver of claim 12, wherein the throttle comprises a thumb control throttle positioned at the handle.

14. The shaver of claim 11, wherein the variable speed drive comprises a forward mode and a reverse mode.

15. The shaver of claim 1, wherein the motor is battery powered, the shaver further comprising the at least one battery.

16. The shaver of claim 15, further comprising quick connects for operating and charging the at least one battery.

17. The shaver of claim 1, further comprising a stand that maintains the shaver in a position with the blade lifted from the floor.

18. The shaver of claim 1, further comprising a transport component that positions wheels between the frame and a floor in a manner that maintains the blade lifted from the floor.
